(19) United States
(12) Patent Application Publication
(10) Pub. No.: US 2014/0265204 A1
(43) Pub. Date: Sep. 18, 2014

(54) Powered Ride-On Vehicle of an Airplane Design With Steer and Tilt Combination and Simulated Combat Capabilities.

(71) Applicant: Jerry L. Lanser, Longmont, CO (US)

(72) Inventor: Jerry L. Lanser, Longmont, CO (US)

(21) Appl. No.: 13/846,886

(22) Filed: Mar. 18, 2013

(51) Int. Cl. F41A 33/02; B62D 1/12; B60R 11/00; B62D 7/10

(52) U.S. Cl. CPC F41A 33/02; B62D 7/10; B62D 1/12; B60R 11/00
USPC 280/124.103; 280/92

(57) ABSTRACT

A motor powered riding vehicle with an airplane appearance consisting of a chassis, body and shell. The chassis is in contact with the ground via the wheels. The body includes a seat for the operator and an area to accommodate the controls and battery, if electric power is used. The shell surrounds the body, and gives form to the type of plane being imitated. The body/shell combination are connected to the chassis at two longitudinal pivot points which allow the body to simulate a banking motion as the rear wheel is turned. In addition, the body can contain a bracket to which a toy gun or some electronic “shooting” device is attached to allow two or more planes to engage in simulated combat.

### BACKGROUND OF THE INVENTION

There are numerous motor powered riding toys on the market today. In general they are scaled down versions of actual vehicles such as cars, trucks, tractors, motorcycles, etc. In addition there are miniature versions of such items as dirt bikes and 4-wheelers for older children and adults. The items designed for younger children, especially, are usually powered by batteries and electric motors while items for older children may be powered by electric motors or fuel powered engines.

Riding toys of this type that have no other function tend to lose their appeal over a period of time and so there has been an emergence of such toys that can haul, dig or race. This is probably one of the reasons that few airplane designs have made it to market since there was little that could be done with them except ride. In addition, most of the airplanes had the rider sitting on the outside of the shell, which is very unrealistic.

There has been an explosion of toys that are designed for the operators to shoot at targets and one another in simulated combat, with paintball, laser guns, foam dart guns being some examples. Paintball players have devised some vehicles to be used in simulated combat such as miniature tanks and personnel carriers but commercially available riding toys with mountings for simulated combat equipment are non-existent.

Others have promulgated different aspects of our invention but it is the novel, unique and unforeseen combination and arrangement of parts that form the basis for this invention and which will provide a heretofore unknown experience for the operator.

For instance, Block claims a riding toy airplane that can be oscillated between front and rear pivot points with a control stick to control the oscillation. It is part of a rocking horse arrangement which is non-mobile and the operator sits on the outside of the shell. Edinburgh is typical of flight simulator devices which produce oscillation or tilt of the operator in response to input from said operator. Once again, these simulators operate at a particular fixed location. Bourne shows a three wheeled vehicle which employs a front and rear pivot combined with a mechanical linkage to cause the body along with the front two steered wheels to tilt when turning. Kirchner is a three wheeled riding toy employing a single steerable rear wheel. It's body is a single unit and derives its tilt by manipulating the axle positioning to the two front wheels. Coil and Klopfenstein claim a three wheel vehicle in which a series of mechanical configurations at the front wheels cause the frame of the tricycle to tilt when those two front wheels are turned. Huntsberger is an example of electric powered riding toys and in this case the vehicle is three wheeled but it does not tilt when turning and the steering is done with the single front wheel.

### SUMMARY OF THE INVENTION

It is, therefore, an object of this invention to provide a much better flying simulation by developing a riding toy which allows the operator to climb inside the “plane” and which gives the operator a more realistic sensation of flying by combining rear wheel steering with a banking motion of the body.

A further object is to engage the interest of the operator for a much longer time by adding the capability of interacting with other planes or targets. This necessarily requires the honing of “flying” skills to be able to accurately engage a target. This is accomplished adding a shooting device, of which there are several options, which is rigidly mounted to the body of the plane and requires that the operator use his “flying” skills to engage other pilots, planes or targets.

It is yet another object to give the operator some historical feel for the difficulty that real life pilots have in engaging in combat with other pilots.

### DESCRIPTION OF THE DRAWINGS

FIG. 1 is a top view of the airplane riding vehicle.

FIG. 2 is a side view of said airplane.

FIG. 3a is part of an exploded view showing the shell of the airplane in perspective

FIG. 3b is part of an exploded view showing the body of the airplane in perspective

FIG. 3c is part of an exploded view showing the chassis of the airplane in perspective

### DESCRIPTION OF THE INVENTION

FIGS. 1 and 2 are side and top views of the airplane. These views contain a few details not shown on FIG. 3. Among these are a rudder 58 attached to shaft 54 for visual enhancement. It also shows one of the options for a gun platform 59 by supports 60 which are attached to the body of the airplane. 61 is a simulated “tommy gun” designed to shoot foam darts. A paintball gun could also be mounted in a similar manner.

FIGS. 3a, 3b, and 3c are perspective views of the three major parts of the invention and illustrate their interconnection. FIG. 3a shows a shell 1 with a preferred embodiment of sheet or molded plastic. A set of short wings 2 and 3 are attached or molded to the side of the shell. In this view a pair of struts 62 and 63 support a top wing 4 to form a biplane appearance. Different wing sizes, shapes and colors can be used to reproduce the appearance of different types of aircraft.

A cowling 5 of molded plastic covers the front of the shell 1 opening and surrounds the front edge of the shell 1 material in such a manner that the shape of the front of the shell 1 is maintained in a circular form. The cowling 5 is attached to the shell 1 in such a manner as to allow easy removal. The removal of the cowling 5 allows easy access to the foot switch 9 and for charging or replacing the battery 8 if electric power is used. A free-spinning propeller 6 is bolted to the cowling with bolt 7 to enhance the appearance. The bottom edges of the shell 1 are attached to the body deck 10 and seat back 11 with staples, screws or rivets.

FIG. 3b shows the body of the plane which consists of a body deck 10 that extends the full length and width of the body space. A solid piece 11 is attached to the base sheet 10 at an angle slightly less than perpendicular which serves as the seat back for the operator. Its' curved top maintains the shape of the of the shell 1 material at the rear of the plane. In addition, on the center of the forward half of the body deck 10 is a set of short vertical walls which form an open topped rectangular box 12. This box 12 encloses the direction/speed controller 13 along with the associated wiring. It also forms an enclosure for the battery 8, if electric power is used.

A foot switch 9 controls the operation of the drive motors 23 & 24 in response to the operators foot pressure. The foot switch 9 has a vertical pin on its' bottom surface which can be inserted into one of a series of holes 14 in the body deck 10 extending linearly rearward from its front edge. This allows the foot switch 9 to be adjusted to fit the leg length of the operator.

FIG. 3b shows two vertical members 15 & 18 solidly connected to and extending vertically upward from the body deck 10. Each vertical member 15 & 18 has a shaft 16 & 19, respectively, at it's top end perpendicularly extending toward the rear of the plane. These shafts 16 & 19 are the two pivot points that connect the body to the chassis.

The preferred embodiment for the body section would be for the body deck 10, the seat back 11 and the center box section 12 to be a single molded piece of plastic, but a combination of wood, metal and plastic would also be viable.

FIG. 3c is a perspective view of the chassis of the plane with the preferred embodiment being welded metallic angles and/or tubing. The main frame 21 has a triangular shape with the base of the triangle toward the front end of the plane and with the sides joining together at the rear of the plane at a vertical sleeve 22 serving as the pivot for the rear wheel assembly.

A fixed axle 30 is mounted to and parallel at the front end of the frame 21 and extends out beyond the sides of the frame 21 for a sufficient distance to accommodate the mounting of the motor/gearbox(s) 23 & 24 and wheels 25 & 26. These are secured on axle 30 with cotter pins 27 & 28. The interfaces between the gearboxes 23 & 24 and wheels 25 & 26 which are many and various are not shown but assumed. The motor/gearboxes 23 & 24 are secured to the frame with straps 31 & 32.

There is a front vertical member 33 securely mounted to the center of the base of the chassis frame 21 and near its top end contains a hole 34 perpendicular to the member 33 in a longitudinal direction in relation to the chassis frame 21. There is also a rear vertical member 35 securely mounted to the chassis frame 21 at a point slightly ahead of the rear sleeve 22 which contains a hole 36 near the top and perpendicular to the member 35 in a longitudinal direction in relation to the chassis frame 21.

There is a crossmember 39 mounted between the side members of the frame 21 midway between the front and back end of the frame 21 and parallel to its front edge. The joystick 40 is connected to a short vertical member 29 centered on crossmember 39 in a movable fashion with bolt 41. The joystick protrudes through hole 42 in the body deck 10 when the body is assembled to the chassis.

This joystick 40 is the means by which the operator controls the steering of the rear wheel via the interconnection of linkage members 43, 44, and 45 between the bottom of the joystick 40 with bolt 47 and the rear wheel yoke tab 46 with bolt 48.

Linkage member 50, which controls the tilt of the body during turning, is on one end also connected to the bottom of the joystick 40 with bolt 47 and connects at its opposite end to a tab 49 on the bottom of the body deck 10 with bolt 51.

There is a steerable rear wheel assembly consisting of wheel 52 connected to yoke 53 with axle 56 which is secured with cotter pin 57. Shaft 54 is vertically connected to the top of yoke 53 and protrudes through sleeve 22 and is secured with cotter pin 55.

An alternate method of propulsion would be to attach a power source (electric or fuel) to the rear wheel 52 via a motor/gearbox or chain and sprocket in lieu of the motor/gearboxes 23 & 24 driving the front wheels 25 & 26.

The body is connected to the chassis by lowering the body over chassis vertical members 33 & 35 and joystick 40. Shaft 16 is inserted into hole 36 and shaft 19 is inserted into hole 34 which are then secured by inserting cotter pins 17 & 20. Linkage member 50 is connected to tab 49 of the base sheet 10 with bolt 51.

Operation of the vehicle requires the operator to seat himself on body deck 10 with legs extended straight forward on the body deck 10 and inside of the shell 1 and his back resting against the back rest 11. The operator would select the desired operating speed and direction by manipulating selector 13. He would then press on switch 9 with his foot to make the airplane move in the desired direction. He could then choose his direction of travel by moving the joystick 40 to the left or right. Moving the joystick 40 to the left, for instance, would cause the rear wheel assembly to rotate on shaft 54 in such a manner as to cause the front of the plane to move in a leftward direction and simultaneously cause the body of the plane to tilt or “bank” such that the left wing 2 would be lower to the ground than wing 3. The reverse would be true for a right turn. This is also helpful for a person teaching a small child how to “fly” the plane in that the teacher can control the direction of the plane by raising or lowering the edge of wing 4.

Although these drawing show a combination battery/electric motor/gearbox propulsion system this is in no way to preclude using other means such as a fuel powered engine.

There are numerous type toy guns on the market today which shoot various type of non lethal projectiles such as foam darts, paintballs, etc. The gun mounting bracket 59 and supports 60 are not intended to show a specific mounting platform for a specific type gun but a generic platform with the intent to show a gun solidly mounted to the body of the plane in such a manner that the direction of the projectiles it shoots is controlled solely by direction of the plane.

An alternative method for combat would be an electronic system in which a laser, infrared or similar type beam would be emitted from the front of the plane. A second plane would have a series of sensors on the front, back, and sides of its shell such that if activated by the beam from plane one would produce some sort of reaction such as beep, whistle or flashing light and could include disablement of the second plane's propulsion system for a time. Each plane would have both a sending and receiving capability. A stationary target with receiving capabilities would be another option such that a single pilot could practice alone and that the target would have exploding noises, flashing lights or other indication if struck by the beam.

1. A motorized powered riding vehicle comprising:
a shell with an airplane appearance,
a body upon which the operator sits and which house the operational controls, and
a tricycle type chassis with a steerable rear wheel, a pair of fixed wheels and a propulsion system.

2. The vehicle of claim 1 in which:
the chassis has two longitudinally separated vertical members.
the body has two longitudinally separated vertical members.
these front vertical members are connected with a shaft and the rear vertical members are joined with a shaft such that the body can freely tilt with respect to the chassis.

3. The vehicle of claim 1 which also has a joystick or similar mechanism which, through a set of mechanical linkages, can simultaneously control the tilt of the body and the steering direction of the rear wheel.

4. A platform rigidly and securely attached to the body or shell of claim 1. whose purpose is to provide a secure and rigid mounting for guns or similar devices which shoot non-lethal projectiles, such as paintballs or darts. The exact design will vary to accept the multiplicity of guns available.

5. A device, electrical or mechanical, mounted to the joystick of claim 3 to remotely operate the guns through an electrical or mechanical interconnection.

6. Electronic circuitry installed in the vehicle of claim 1 to be used as an alternative to the guns in simulated combat or target practice to include:
an electronic device capable of sending out a directional beam, such as a laser, infra-red, or similar. The beam to project forwardly from the front of the plane. This device to be securely attached to the platform of claim 4.
a device such as a push-button attached to the joystick of claim 3 which would activate the beam.
a series of receivers or sensors strategically mounted to the shell of the vehicle of claim 1 or to a stationary target. These receivers to be activated by the electronic beam from a device mounted in a separate vehicle.
an audible or visual signal to the operator that a connection has been made between the beam and the sensor. The circuit could also be capable of interrupting the propulsion circuit of electrically powered vehicles of claim 1.
